(19) United States
(12) Patent Application Publication
(10) Pub. No.: US 2016/0033676 A1
(43) Pub. Date: Feb. 4, 2016

(54) Estimating Material Properties

(71) Applicants: Technological Resources Pty Ltd, Brisbane (AU); The University of Sidney, Sydney (AU)

(72) Inventors: Danielle K. Robinson, Brisbane (AU); Arman Melkumyan, Sydney (AU); Anna Chlingaryan, Sydney (AU)

(21) Appl. No.: 14/772,522

(22) PCT Filed: Jan. 16, 2014
(86) PCT No.: PCT/AU2014/000025

§ 371 Date: Sep. 3, 2015

(30) Foreign Application Priority Data
Mar. 5, 2013 (AU) 2013900742

(51) Int. Cl. G01V 99/00; G06F 17/10

(52) U.S. Cl. CPC G01V 99/005; G06F 17/10

(57) ABSTRACT

This disclosure relates to updating an estimate for a material property of a volume, for example, updating the estimate of iron concentration in a block of a mine block model. The estimate is based on values of one or more model parameters. A processor receives a measurement of the material property outside the volume. Then, the processor determines updated values for the one or more model parameters based on the estimate and the measurement and determines an updated estimate for the material property of the volume based on the updated values for the one or more model parameters and the measurement. Since a measurement outside the volume is used to determine updated model parameters and an updated estimate of that volume, the model is more accurate and the estimate for the material property of the volume is also more accurate although measurements within that volume are not available.

### TECHNICAL FIELD

This invention relates to updating an estimate for a material property of a volume, for example but not limited to, updating the estimate of iron concentration in a block of a mine block model.

### BACKGROUND ART

Significant funds are invested into the development of a mine. The development of a mine includes provision of mobile machines, such as off-road trucks, shovels, blasthole drills and a processing plant. Processing plants may include plants for bulk commodities, such as coal washing plants or iron ore crushers, as well as concentration plants to separate the desired material, such as gold, from the waste. The economic viability of the mine development mainly depends on the material that is extracted from the ground. Therefore, resource companies explore the in-ground material properties before commencing development of the mine.

FIG. 1 illustrates a simplified exploration scenario 100. A drill 102 drills a drill hole 104 and extracts a core from the drill hole 104. Based on an analysis of the core, a resource 106 is located. Additional drill holes give a more accurate view of the exact dimension of the resource 106 but also incur a significant cost, such as the cost of diamond drill bits. Therefore, a resource company is presented with a trade-off between upfront cost and information quality.

Once the resource company is sufficiently informed about the shape of the resource, the resource company starts the development of a new mine. Blasthole drills are dispatched and the drilled blastholes are loaded with explosives. After blasting, digging equipment, such as shovels, move to the blast site and start loading the cracked rock onto trucks, which transport the material to a waste pile. When the loaded rock contains the desired material, the trucks transport the material to a processing plant.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

In a first aspect there is provided a computer-implemented method for updating an estimate for a material property of a volume, the estimate being based on values of one or more model parameters, the method comprising:
(a) receiving a measurement of the material property outside the volume;
(b) determining updated values for the one or more model parameters based on the estimate and the measurement; and
(c) determining an updated estimate for the material property of the volume based on the updated values for the one or more model parameters and the measurement.

It is an advantage that a measurement outside the volume is used to determine updated model parameters and an updated estimate of that volume. As a result, the model is more accurate and the estimate for the material property of a volume is also more accurate although measurements within that volume are not available. In turn, a planning tool that uses the updated estimate can determine a more efficient use of resources based on the more accurate input data and the entire operation becomes more profitable. Updating models using traditional methods is a very time and resource intensive process. One of the benefits of the proposed method is that it is less time and resource intensive. As a result, many more models with better information can be calculated for the mining teams.

The measurement may be point data, a surface average or a line average and may be associated with a first bench of a mine pit.

The volume may be associated with a second bench of a mine pit and the second bench is below the first bench. The second bench may be immediately below the first bench.

The measurement may be a drill hole assay, may be obtained while drilling and may be based on a drill penetration rate.

The measurement may be based on a hyperspectral surface scan.

The material property may be a material concentration.

The method may further comprise generating a display of the volume, such that the visual appearance of the volume is based on the updated estimate for the material property.

The display may comprise a visual representation of at least part of a mine pit including multiple volumes.

The volume may have a first number of dimensions and the measurement may have a second number of dimensions being less than the first number of dimensions.

In a second aspect there is provided software, that when installed on a computer causes the computer to perform the method of the first aspect.

In a third aspect there is provided a computer system for updating an estimate for a material property of a volume, the estimate being based on values of one or more model parameters, the computer system comprising:
a data port to receive a measurement of the material property outside the volume;
a processor to determine updated values for the one or more model parameters based on the estimate and the measurement and to determine an updated estimate for the material property of the volume based on the updated values for the one or more model parameters and the measurement; and
a data store to store the updated estimate.

In a fourth aspect there is provided a computer implemented method for modelling data, the method comprising:
(a) receiving a first set of data values, each value being based on an estimated physical property having a first number of dimensions;
(b) receiving a second set of data values, each value being based on an estimated physical property having a second number of dimensions; and
(c) selecting based on the first and second number of dimensions one of multiple functions to model the first and second set of data values.

It is an advantage that a function is selected based on the first and second number of dimensions. As a result, the model adapts to different dimensionality of the input parameters and is capable of fusing data with different dimensionality. Therefore, more data can be used to train the model and this leads to a more accurate modelling of the data.

The method of the fourth aspect may further comprise determining estimated data values based on the first set of data values, the second set of data values and the selected one of multiple functions.

The method of the fourth aspect may further comprise generating a display comprising a graphical representation of the estimated data values.

Each data value may be associated with one location of the display and the colour of that point in the visual representation is based on that data value.

The method of the fourth aspect may further comprise:
receiving a request for an estimated data value at a request location;
determining the estimated data value based on the request location, the first set of data values, the second set of data values and the selected one of multiple functions; and
sending the estimated data value.

The first set of data values may be based on an average of the estimated first physical property over the first number of dimensions and the second set of data values is based on an average of the estimated second physical property over the second number of dimensions. The first number of dimensions may be three.

The method of the forth aspect may further comprise determining the average of the estimated first physical property using a geological model.

The first and second physical properties may be material concentrations. The second number of dimensions may be one.

Each of the second set of data values may be based on an average of the estimated second physical property over at least part of a drill hole.

The multiple functions may be covariance functions.

Where the second number of dimensions is smaller than the first number of dimensions the selected function may be based on a difference between integrals of a basis function.

The method of the fourth aspect may further comprise determining parameters of the multiple functions based on the first and second set of data values.

The multiple functions may be based on one or more of:
squared exponential,
exponential,
Matern 3/2, and
Matern 5/2.

Selecting the function may be based on a distance between a modelling point and the anchor point.

In a fifth aspect there is provided software, that when installed on a computer causes the computer to perform the method of the fourth aspect.

In a sixth aspect there is provided a computer system for modelling data, the computer system comprising:
a data port to receive a first set of data values, each value being based on an estimated physical property having a first number of dimensions, and to receive a second set of data values, each value being based on an estimated physical property having a second number of dimensions; and
a processor to select based on the first and second number of dimensions one of multiple functions to model the first and second set of data values.

In a seventh aspect there is provided a data format for storing on a non-transitory medium model data, the data format comprising:
a first set of data values, each value being based on an estimated first physical property having a first number of spatial dimensions;
a second set of data values, each value being based on an estimated second physical property having a second number of spatial dimensions, the second number of spatial dimensions being smaller than the first number of spatial dimensions,
   wherein each value of the first set and each value of the second set is associated with an anchor point and a size vector, the anchor point and the size vector having the first number of spatial dimensions.

It is an advantage that the values of both the first and the second set are associated with an anchor point and size vector having the same number of dimensions. As a result, the data format is unified for different input dimensions which means that a modelling method can process data with different dimensions without data re-formatting.

In an eighth aspect there is provided a computer implemented method for storing on a non-transitory medium data to be fused with a first set of data values, each value being based on an estimated physical property having a first number of spatial dimensions, the method comprising:
receiving a second set of data values, each value being based on an estimated physical property having a second number of spatial dimensions, the second number of spatial dimensions being smaller than the first number of spatial dimensions; and
storing for each value of the second set an association with an anchor point and a size vector, the anchor point and the size vector having the first number of spatial dimensions.

In a ninth aspect there is provided software, that when installed on a computer causes the computer to perform the method of the eighth aspect.

In a tenth aspect there is provided a computer system for storing on a non-transitory medium data to be fused with a first set of data values, each value of the first set of data values being based on an estimated physical property having a first number of spatial dimensions, the computer system comprising:
a data port to receive a second set of data values, each value being based on an estimated physical property having a second number of spatial dimensions, the second number of spatial dimensions being smaller than the first number of spatial dimensions; and
a processor to store for each value of the second set an association with an anchor point and a size vector, the anchor point and the size vector having the first number of spatial dimensions.

Optional features described of any aspect, where appropriate, similarly apply to the other aspects also described here.

### BRIEF DESCRIPTION OF DRAWINGS

FIG. 1 illustrates a simplified exploration of a deposit.

An example will be described with reference to

FIG. 2 illustrates a basic schematic of a simplified open-pit mine.

FIG. 3 illustrates a computer system for modelling data and determining an updated estimate for a material property of a volume.

FIG. 4 illustrates a method for updating an estimate for a material property of a volume.

FIG. 5 illustrates a block model for in-ground material property.

FIGS. 6a, 6b and 6c illustrate several example measurements.

FIG. 7 illustrates a computer implemented method for modelling data.

### BEST MODE FOR CARRYING OUT THE INVENTION

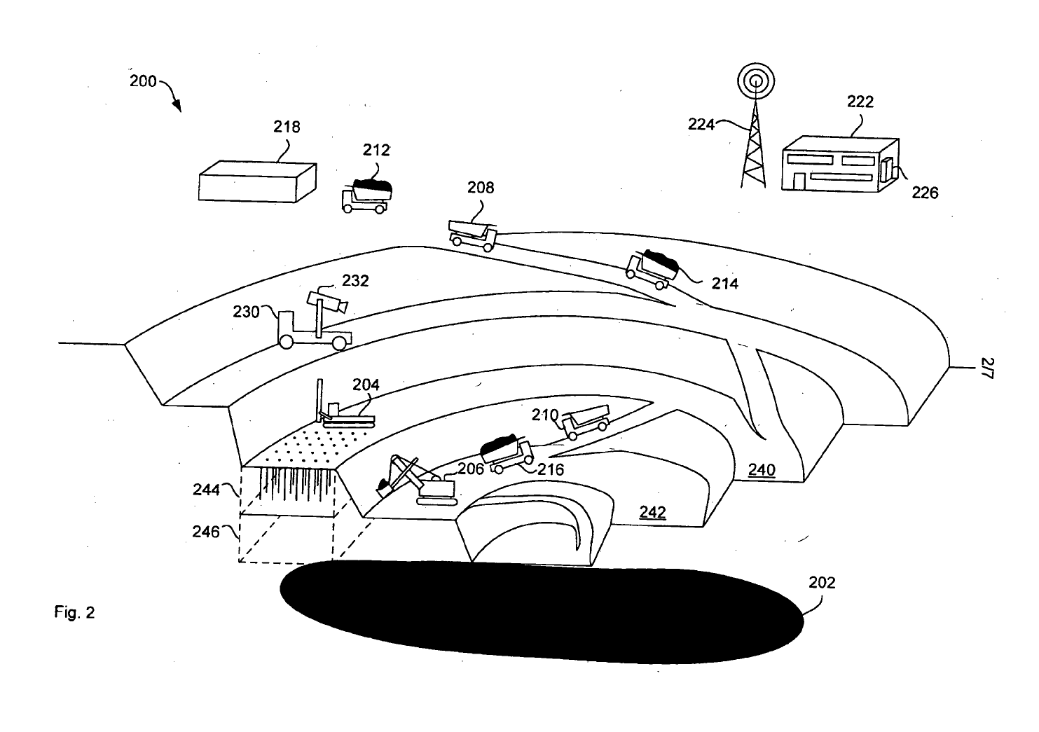

FIG. 2 illustrates a simplified open-pit mine 200. Although FIG. 2 shows an open-pit operation, it is to be understood that the invention is equally applicable to underground operations. The mine 200 comprises an iron ore deposit 202, a blasthole drill 204, a shovel 206, empty trucks 208 and 210 and loaded trucks 212, 214 and 216. As mentioned above, the drill 204 drills blastholes, the material is blasted and then loaded onto truck 210. The truck 210 then transports the material to a processing plant 218. While some of the following examples relate to the mining of iron ore, it is to be understood that the invention is also applicable to other mining operations, such as extraction of coal, copper or gold.

The mine further comprises a control centre 222 connected to an antenna 224 and hosting a computer 226. The control centre 222 monitors operation data received from the mining machines wirelessly via antenna 224. In one example, the control centre 222 is located in proximity to the mine site while in other examples, the control centre 222 is remote from the mine site, such as in the closest major city or in the headquarters of the resource company. In the example of FIG. 2, the mine 200 also comprises a survey vehicle 230 with a hyperspectral camera 232. A laser scanner may also be used instead of or in addition to the hyperspectral camera 232.

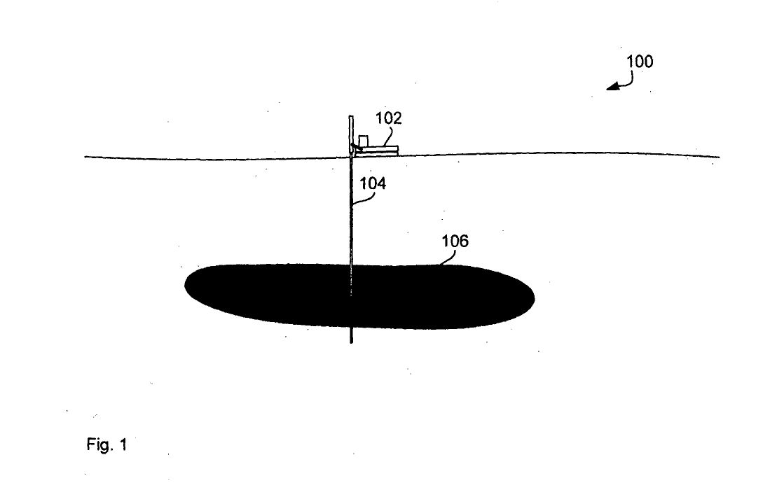

Although the iron ore deposit 202 is indicated as a solid region, it is to be understood that the exact shape of the deposit 202 is not known before it is mined. A modelling software executed on computer 226 provides an estimation of the deposit 202 based on the exploration drilling as explained with reference to FIG. 1. However, as mentioned earlier, the cost of exploration drilling is high and therefore, the modelled size of the deposit 202, that is the material property for particular volumes, is locally inaccurate, which makes it difficult to plan the mining operation.

In order to provide a more accurate estimate, the deposit 202 is continuously updated by measurements received from the blasthole drill 204, which means that the estimate is of a better quality and of higher use to the resource company. This is possible where the material properties of the deposit 202 and the properties of the material drilled by blasthole drill 204 are correlated. Therefore, information from the blasthole drill 204 allows to reduce the uncertainty of the estimation of the deposit 202.

In this example, the mine layout comprises several benches, such as bench 240 on which blasthole drill 204 is located and bench 242, which is below bench 240 and on which excavator 206 is located. Bench 240 comprises a first volume 244 of material between the level of the blasthole drill 204 and the level of the shovel 206. Bench 242 comprises a second volume 246 of material below the shovel 206 and above the next level below.

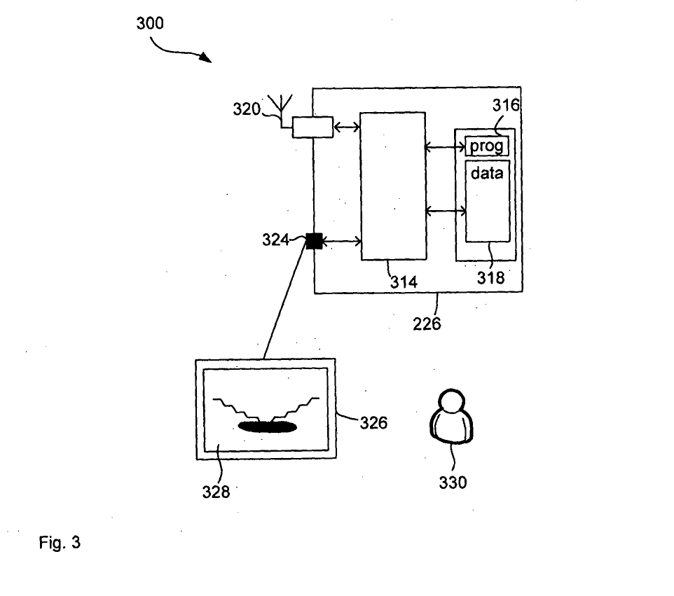

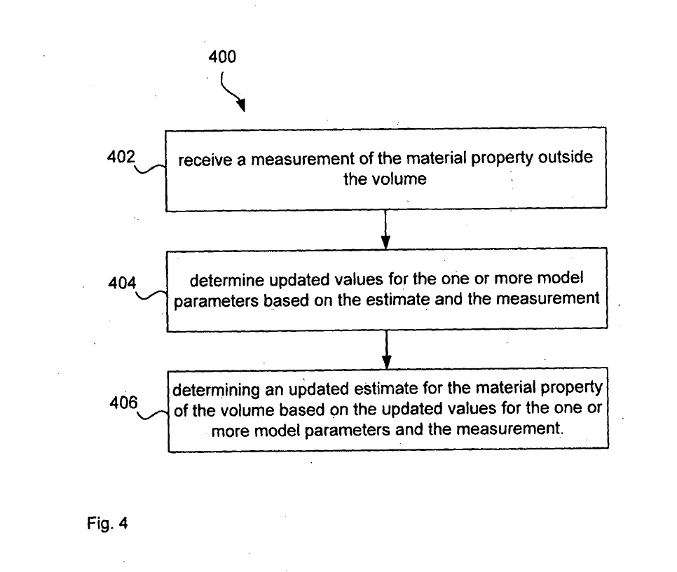

FIG. 3 illustrates a computer system 300 comprising computer 226 located in control centre 222 in FIG. 2. The computer 226 includes a processor 314 connected to a program memory 316, a data memory 318, a communication port 320 and a user port 324. Software stored on program memory 316 causes the processor 314 to perform the method in FIG. 4, that is, the processor receives measurements and determines an updated estimate for a material property of a volume as described below. The processor 314 receives data from data memory 318 as well as from the communications port 320 and the user port 324, which is connected to a display 326 that shows a visual representation 328 of a geological model to an operator 330.

Although communications port 320 and user port 324 are shown as distinct entities, it is to be understood that any kind of data port may be used to receive data, such as a network connection, a memory interface, a pin of the chip package of processor 314, or logical ports, such as IP sockets or parameters of functions stored on program memory 316 and executed by processor 314. These parameters may be handled by-value or by-reference in the source code. The processor 314 may receive data through all these interfaces, which includes memory access of volatile memory, such as cache or RAM, or non-volatile memory, such as an optical disk drive, hard disk drive, storage server or cloud storage. The computer system 300 may further be implemented within a cloud computing environment

FIG. 4 illustrates a method 400 for updating an estimate for a material property of a volume. In one example, the material property is iron concentration, such as a percentage of iron (Fe) in the iron ore. In other examples, the material property is the concentration of different materials, such as copper, the hardness of the material or the lump ratio. Lump is a term for pieces of iron ore that are larger than a threshold size, such as 25 mm and generally attract a higher price on the world market than fines, which are below that threshold size. The lump ratio is a weight ratio of lump size pieces to fines and is an indicator for the value of the material. In one example, the volume is a cuboid but it is to be understood that the method is equally applicable to other regular volumes, such as tetrahedron or honeycomb structures, and irregular volumes. The volume may also be a block of a block model.

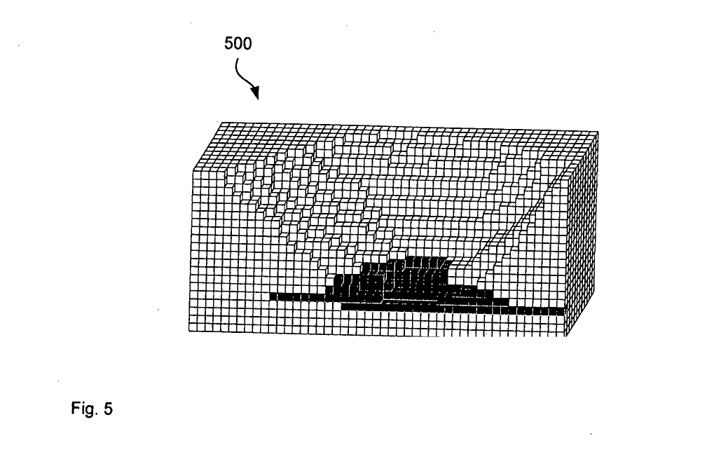

FIG. 5 illustrates a block model 500 for in-ground material property. The block model partitions the underground material of a mine into multiple volumes, such as blocks, and assigns an estimate of the material property to each block. In this example, the blocks are cubes but other three-dimensional shapes are also possible to define a volume, such as a honeycomb structure. In the example of FIG. 5, a white block indicates waste and a black block indicates the deposit, such as an iron ore deposit. In one example, a block is considered waste if the concentration of iron in the block is below a predetermined threshold, such as 50% iron, and vice versa, a block is considered as part of the deposit if the iron concentration is above the threshold.

The original estimate that is later updated is based on values of model parameters. For example, the estimate is determined for blocks of the model 500. This means, the processor 314 evaluates the model and the result of the model evaluation is the estimate of the material property. In this example, the horizontal resolution of the model 500, that is, the number of blocks in a horizontal layer of model 500, is higher than the number of exploration drill holes 104 in FIG. 100. As a result, many blocks of model 500 are between drill holes and therefore, no measurement of the material property is available.

In one example, determining an estimate for the material property of the blocks of the model 500 is based on interpolation, such as by using a Gaussian Process (GP). The covariance function of the Gaussian Process defines the covariance between two values of the model and declines with the distance between the two values. Therefore, the covariance function defines whether the data changes rapidly or is relatively smooth. Different types of covariance functions are suitable, which are listed further below. Each covariance function has model parameters that characterise the covariance function. In one example, the model parameters are hyperparameters of the Gaussian Process, such as a scaling factor σ₀, a noise component σₙ and a characteristic length l, which describes the distance over which points are correlated in a certain neighbourhood. For simplicity of presentation, a one dimensional characteristic length is used here but it is to be understood that two or three dimensional vectors may equally be used. In one example, characteristic length scales lₓ, l_{y}, l_{z} are used, which define how fast correlations between points decrease as points get further apart in the corresponding directions. Since these parameters define the model, the estimation of the material property using the model is based on the model parameters.

Determining the parameters of the covariance function is typically performed based on the available data, that is, the exploration data of FIG. 1 potentially in combination with blast hole assays. In another example, geological spatial information may be used as a starting point. An optimisation algorithm, such as a steepest gradient descent algorithm, is used to iteratively optimise a cost function which is based on the parameters such that the fit to the given data is optimal. Closed form partial derivatives of the cost function with respect to the parameters significantly speed up the process.

In one example, the estimate of the material property for one volume is a weighted sum of material properties of the surrounding volumes determined by the exploration drillings of FIG. 1. The weights are determined by the covariance function such that values with a high covariance have a large weight.

The first step of method 400 in FIG. 4 is to receive 402 a measurement of the material property outside the volume. Outside the volume means that at least part of the measurement is outside the block that is being estimated. In the example of FIG. 2, the measurements are of material property of volume 244, which is outside volume 246. In another example, a drill hole in bench 240 may reach into a block in bench 242 but a part of the drill hole is outside bench 242, that is, in bench 240. Therefore, the measurement is outside the volume that models bench 242.

In the example of FIG. 2, the processor 314 in computer 226 receives measurement data from blasthole drill 204 and the hyperspectral camera 232. This data may have various different forms.

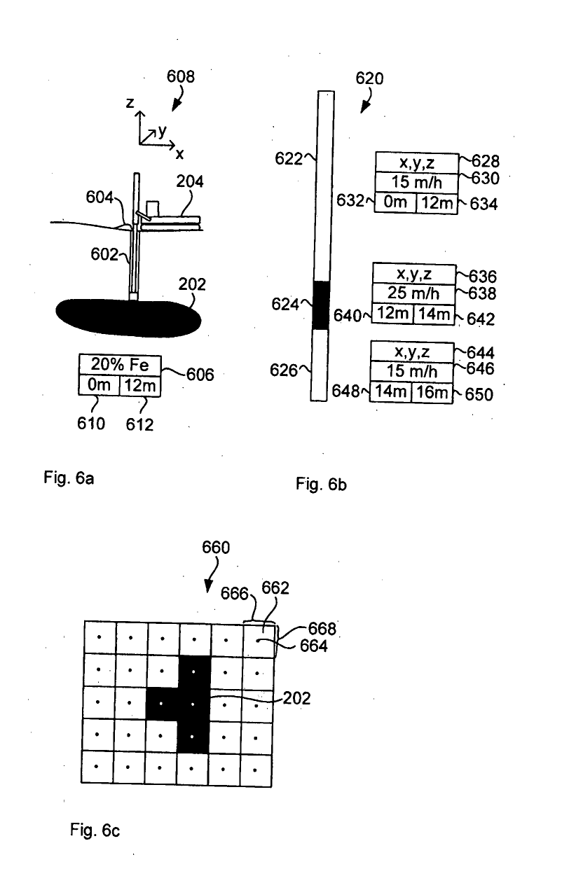

FIGS. 6a, 6b and 6c illustrate several example measurements that may be used by the method. FIG. 6a illustrates a blasthole 602 drilled by blasthole drill 204 in a direction towards the deposit 202. While the blasthole 602 is being drilled, drill chips are blown out of the blasthole 602 and form a well 604 around the opening of the blasthole 602. An on-site worker or a sampling machine then obtains a sample of the drill chips and chemically analyses the sample to measure the material property in the blasthole 602. Since the drill chips are a mixture of chips from throughout the blasthole, the measurement represents a line average 606 of the material property along the length of the blasthole. In this case the line average 606 is 20% of iron along the length of the blasthole.

The line average 606 is associated with a position 608 of the blasthole in form of a set of x, y and z coordinates, such as longitude, latitude and elevation. In one example, the position is obtained by a GPS or differential GPS receiver mounted on the blasthole drill 204. The line average 606 is further associated with a start point 610 and an end point 612. The end point 612 is also the depth of the blasthole 602 and the start point 610 may be omitted. It is to be noted that in some examples, the average is only over a part of the drill hole instead of the entire drill hole.

FIG. 6b illustrates a different example of a measurement of the material property. In this example, the measurement is a drill hole assay 620 that is extracted from the blasthole 602, which means that multiple values for the material property at different depth of the blasthole are available. Of course, the drill hole assay may be for a separate exploration hole rather than a blasthole. In one example, the assay is extracted by using a core drill and analysing the core in a chemical laboratory. In a different example, the hardness of the rock is measured by measuring the penetration rate or the torque on the drill string while drilling.

In the example of FIG. 6b, the assay 620 comprises a first region 622, a second region 624 and a third region 626. Each region is associated with a separate measurement. In this example, iron ore is mined and the blasthole drill 204 drills through the first region 622 with a relatively low penetration rate of 15 metres per hour, which indicates a relatively hard rock and therefore can be an indicator of waste. The measurement of the first region 622 is associated with coordinates 628 of the first region which indicate the centre of the first region 622. The measurement includes a value 630 of the measurement of 15 m/h and is further associated with the beginning 632 and the end point 634 along the line of the hole. The first region 622 may be considered as a line average between the beginning 632 and end point 634. Alternatively, the first region 622 may be considered as point data where the measurement 630 is associated with the point as defined by the coordinates 628. In one example, the decision between line average and point data is made based on the length of the regions. If the assay 620 comprises many short regions, such as 10 regions all of which being shorter than 1 metre, then the regions are considered as point data. Regions which are longer, such as longer than 1 metre, are considered as line average.

Similar to the first region 622, the second region 624 is associated with coordinates 636, measurement value 638 beginning 640 and end point 642. The third region 626 is also associated with coordinates 644, measurement value 646, beginning 648 and end point 650. The beginning and end points of the regions 622, 624 and 626 may be calculated when needed based on the coordinates of the regions and not stored with the assay 620.

FIG. 6c illustrates yet another example of a measurement of the material property. In this example, the measurement is a two-dimensional hyperspectral image 660 of the surface of the mine captured by the hyperspectral camera 232 in FIG. 2. The image 660 comprises a number of image locations, such as pixel 662. Pixel 662 covers an area of the mine 200 depending on the distance of the camera 232 from the ground, the focal length of the camera lens, the resolution and the size of the imaging sensor. Each pixel is associated with a pixel location and a measurement value that represents the material property of the ground at that pixel location. The processor 314 associates each pixel location with a geographical location, such as by triangulation based on a separate distance measurement or depth map.

For example, pixel 662 covers an area of 1 metre by 1 metre where the shovel 206 is located in FIG. 2. Such an area is on the surface of volume 246 and therefore also said to be outside volume 246. The image sensor captures the radiance at that location for a number of different wavelength, such as 1000 samples between infra-red to ultra-violet. Typically, some of these samples lie outside the visible spectrum. The samples at the location represent a radiance spectrum and based on a known spectrum of iron, the iron concentration at that location can be determined as a measurement value. This measurement value is then associated with the pixel location or the geographical location of that pixel location. In the example of FIG. 6c, the pixel locations at the periphery of the image 660 are white and therefore indicate a low iron concentration, which is waste. In contrast, the pixel locations at the centre of the image 660 are black and therefore indicate a high iron concentration, which is the deposit 202 in FIG. 2.

As explained with reference to FIG. 6b, the measurement values of the pixels may be considered as surface averages associated with a centre coordinate 664, a width 666 and a length 668 or as point data associated with only the centre coordinate 664.

In the following example, a measurement in form of a line average as explained with reference to FIG. 6a is used. In this case, the mine planning engineer or the mine planning software, has determined that the first bench 240 on which the blasthole drill 204 is currently operating needs to be blasted. This decision is made and does not require an update of material estimates of that bench while the blastholes are drilled. However, the planning of further blasting of the second bench 242 below the first bench 240 at a later stage is not yet finalised. This means that a more accurate update of material estimates of the second bench 242 supports the planning tool. Since the material typically does not change rapidly from the upper bench 240 to the lower bench 242, the measurement from the blasthole drill 204, which is associated with the upper bench 240, is used to update the estimate of material property of the block 246 associated with the lower bench 242. An association of the measurement with a bench may be implemented by storing the measurement as a number value together with a unique bench identifier as one record in a database. As mining progresses more and more benches get drilled and blasted providing new information which can be fused with the model to update and improve it.

It is noted here that the bench 242 in FIG. 2 is immediately below bench 240. However, this is not necessary since the estimate of a volume in a lower bench may be updated using measurements from a higher bench even if one or more benches are between the lower bench and the higher bench. The larger the distance between the volume and the measurement, the less influence the measurement has on the estimate but the estimate may still be better, that is, may have a higher confidence, than without using the measurement in cases where the measurement and the estimate are geologically correlated.

It is now referred back to method 400 in FIG. 4 performed by processor 314 in FIG. 3. As explained earlier, the iron content is estimated by a Gaussian Process based on a covariance function having model parameters scaling factors σ₀, σₙ and the characteristic length l, or characteristic length scales lₓ, l_{y}, l_{z}. These model parameters were initially determined based on exploration data as explained with reference to FIG. 1. Since more data is now available from blasthole drill 204, the processor 314 performs an optimisation to fit the model to the new data. As a result, the processor 314 uses the new data to determine 404 updated values for σ₀, σₙ and l, or lₓ, l_{y}, l_{z}, based on the estimate and the measurement from the blasthole drill 204. The exact mathematical description of the updating process is provided further below.

Since the model parameters σ₀, σₙ and l, or lₓ, l_{y}, l_{z}, are updated based on new data from the blasthole drill 204, the model can provide a more accurate estimate of the material property. The processor 314 therefore evaluates the enhanced model to determine 406 an updated estimate for the material property of the volume. Since the processor uses the updated model, this updated estimate is based on the updated values for the model parameters σ₀, σₙ and l, or lₓ, l_{y}, l_{z}, and the measurement from the blasthole drill 204.

The processor 314 may use the updated estimates for the material property to generate a display to show the estimates to the operator 330 on display device 326. The visual appearance of each block is based on the updated estimate such that the operator can visually determine the material property. In one example, the visual appearance is the colour and the colour scale represents high grade (Fe>60%) in red, low grade (55%<Fe<60%) in green and waste (Fe<55%) in blue.

Following this scheme, the processor 314 may generate a display of a part of the mine pit comprising multiple volumes, such as blocks, as shown in FIG. 5. The display may be overlaid with an image of the mining operation as shown in FIG. 2. As a result, the display 328 comprises a visual representation of that part of the mine pit. For example, a three-dimensional image of the mine may be displayed and the iron concentration of a particular bench is shown colour coded as an overlay of the image.

In one example, generating a display comprises presenting the data to operator 330. In other examples, generating a display comprises creating and storing an image file, such as a png file, or generating instructions for a device to present a graphical representation to the operator 330. The receiving device may be a screen, a heads-up display, a printer or any other display device.

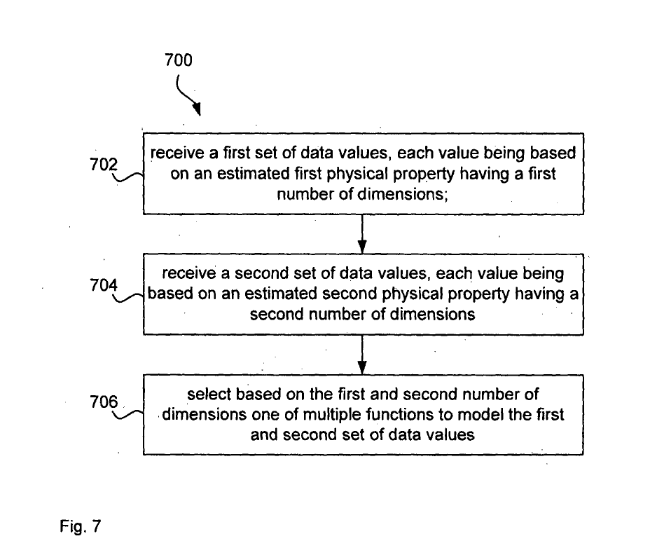

FIG. 7 illustrates a computer implemented method for modelling data as performed by processor 314. The method commences by receiving 702 a first set of data values. Each value is based on an estimated first physical property having a first number of dimensions. In one example, the first set of data values are data values estimated by the geological block model 500 in FIG. 5, such as Rio Tinto's ERP model. It is noted that the model may be any of kind. In this example it is the EPR model or the external regularised model. In this case it means that the selected mining units are considered and the metallurgical regressions are added.

The first physical property, in this example, is the concentration of iron in a three-dimensional block in the ground. This means that the first physical property is a volume average and therefore, has three dimensions. In computer system 226, the first set of data values may be represented by a floating point variable for the data value and three integer variables for the three dimensions, that is, sizes of the block in the model in millimetres. As mentioned earlier, receiving the data values may also comprise calling a function of the API of the model and receiving the data values in the form of return values or changed values of variable pointers.

The next step of method 700 is to receive 704 a second set of data values. Each value of the set of second data values is based on an estimated physical property having a second number of dimensions. As explained with reference to FIG. 6, this second set of data values may have various different numbers of dimensions. In one example, the second set of data values are line averages having one dimension of iron concentration of a blasthole received from blasthole drill 204.

A Gaussian process may be used to infer the elevation at any location in a terrain region based on measured elevation values at certain measurement locations. Such a method can only process elevations as measurement input and can therefore not be applied where estimates of material properties need to be processed.

In order to overcome this problem, processor 314 has multiple covariance functions available and method 700 comprises selecting based on the first and second number of dimensions one of the multiple functions to model the first and second set of data values.

In another example, the processor 314 receives one or more further sets of data values with respective numbers of dimensions and selects one of the multiple functions based on these numbers of dimensions to model the sets of data values.

The selected covariance function may then be used by the processor 314 to determine estimated material concentrations at any location of the modelled region. In the example above, this estimate is based on the previously modelled concentration, the measured drill hole data and the covariance function.

The estimated material concentration may either be used as an input to a mine planning tool or other software, or to generate a display comprising a graphical representation of the estimated data values at different locations of the mine.

Where the estimated material concentration is used as an input to other tools, the processor 314 receives a request from that tool for an estimated data value. This request is associated with a request location, that is the location for which the estimate is requested. This location may simply be the entire mine, which means an estimate is requested for each volume of the mine model. The processor 314 then performs the estimation step, which means that the processor 314 determines the estimated data value based on the request location, the modelled data values, the measured data values and the selected covariance function. Finally, the processor 314 sends the estimated data value to the requesting tool. As explained for receiving data, the sending of data may be via a device interface, such as LAN or USB, a memory interface, a chip connector, a parameter of an API function or any other way of data transmission.

A detailed mathematical description of the updating process will now be provided. In one example, the model consists of grades of elements averaged over 15 m×15 m×10 m blocks. The blasthole assays represent average values of elements' grades along blast holes which can have different lengths. Therefore, to enable fusion of the model with assays two kinds of quantities are correlated: volume averages and line averages.

For both the estimates and blasthole assays it is possible to represent the i-th input as a volume Vᵢ with its middle point Aᵢ=(aᵢ₁,aᵢ₂,aᵢ₃) and three sizes: length, width and height Hᵢ=(hᵢ₁,hᵢ₂,hᵢ₃). As the blasthole assays represent vertical lines, for them hᵢ₁=hᵢ₂=0 and hᵢ₃≠0. For the model dataset hᵢ₁=hᵢ₂=15 and hᵢ₃=10.

Using this unified representation the model and blasthole assay datasets can be combines into one:

$$X = [ \begin{matrix}{A}_{1}^{EPR} & {A}_{2}^{EPR} & … & {A}_{{N}_{EPR}}^{EPR} & {A}_{1}^{BH} & {A}_{2}^{BH} & … & {A}_{{N}_{BH}}^{BH} \\ {H}_{1}^{EPR} & {H}_{2}^{EPR} & … & {H}_{{N}_{EPR}}^{EPR} & {H}_{1}^{BH} & {H}_{2}^{BH} & … & {H}_{{N}_{BH}}^{BH}\end{matrix} ]$$

where Aᵢ^{EPR}, Hᵢ^{EPR}, Aᵢ^{BH}, Hᵢ^{BH}εR³ which can be written as

$$X = [ \begin{matrix}{A}_{1} & {A}_{2} & … & {A}_{N} \\ {H}_{1} & {H}_{2} & … & {H}_{N}\end{matrix} ] \\ {A}_{i} , {H}_{i} ∈ {R}^{3} , i = 1 : N \qquad ( 1 )$$

where N is the combined number of inputs in the model and blasthole datasets.

Equation (1) represents a data format for the first set of data values V₁ to V_{NEPR} and the second set of data values V_{NEPR+1} to V_{NEPR+NBH}. In the example, of the drill hole line average, the first set of data values are three-dimensional while the second set of data values are one-dimensional. Each of the data values Vᵢ is associated with an anchor point Aᵢ and a size vector Hᵢ. As noted in Equation (1), both the anchor point Aᵢ and a size vector Hᵢ have the same number of spatial dimensions as the first set of data values.

In order to store the data, processor 314 receives the second set of data values. The second set of data values is to be fused with the first set of data values, which means that both data sets contribute to a single result. The result is the updated values of the model parameters and the updated estimate for the material property. As mentioned earlier, each value is based on an estimated physical property having a second number of spatial dimensions, the second number of spatial dimensions being smaller than the first number of spatial dimensions. The processor 314 then stores for each value of the second set an association with an anchor point and a size vector. The anchor point and the size vector have the first number of spatial dimensions as explained above.

The corresponding observations of the iron grades or concentrations can be represented as

$$Y = [ {y}_{1} , {y}_{2} , … , {y}_{N} ] \\ where \\ {y}_{i} = \frac{1}{{V}_{i}} {\int }_{{V}_{i}}^{ } f ( x ) d x + {ɛ}_{i} . \qquad ( 2 )$$

In Eq. (2) εᵢ is an observation noise which has a normal distribution with zero mean and σᵢ² variance, i.e. εᵢ˜N(0,σᵢ²).

Mathematically, the task is to model the inputs (1)-(2) and determine estimates for the blocks of the model.

It is noted that using the developed unified representation the fusion problem is formulated as a single task modelling problem by using multiple information sources (model and blasthole assays) to model a single chemical element, in this case iron.

To apply Gaussian processes (GPs) to the modelling problem defined above a covariance function is used that represents correlations between volume averages, line averages and point measurements. In the following description a generic expression is derived of such a function using the unified mathematical representation (1)-(2). Within the obtained generic expression the following covariance functions may be used as a basic covariance function: Squared Exponential, Exponential, Matern 3/2 and Matern 5/2.

Consider the function ƒ(x):R^{D}→R. If k(x,x′)=cov(ƒ(x),ƒ(x′)) is the covariance between ƒ(x) and ƒ(x′) and C is some region of integration then from the basic relationships E[αA+βB]=αE[A]+βE[B]; cov(A,B)=E[(A−E[A])(B−E[B])]cov(A+B,C)=cov(A,C)+cov(B,C); cov (A,B)=0 if A and B are independent it follows that

cov(∫_{c}ƒ(s)ds,ƒ(x))=∫_{c}k(s,x)ds. (3)

Assume that the covariance function between ƒ(x) and ƒ(x′) has the form

$$cov ( f ( x ) , f ( {x}^{′} ) ) = K ( x , {x}^{′} ) = {\prod }_{m = 1}^{D} ϕ ( \frac{{x}_{m} - {x}_{m}^{′}}{{l}_{m}} ) \qquad ( 4 )$$

where lₘ is a length scale hyper parameter along the corresponding axis and

$$ϕ ( t ) = \frac{d Φ}{d t} = {Φ}^{′} \\ ϕ ( t ) = \frac{{d}^{2} Ψ}{d {t}^{2}} = {Ψ}^{″} \qquad ( 5 )$$

Using Eqs. (3)-(5) the following formula can be obtained for the covariance between the observations of our fusion task:

$$\begin{matrix} cov ( {y}_{i} , {y}_{j} ) = cov ( {u}_{i} , {u}_{j} ) + {σ}_{i}^{2} {δ}_{ij} & ( 6 ) \\ cov ( {u}_{i} , {u}_{j} ) = cov ( {y}_{i} , {u}_{j} ) = cov ( {u}_{i} , {y}_{j} ) = {\prod }_{m = 1}^{D} \{ \begin{matrix}\frac{{l}_{m}^{2}}{{h}_{i , m} {h}_{j , m}} R ( {a}_{i , m} , {a}_{j , m} , {h}_{i , m} , {h}_{j , m} , {l}_{m} ) , & if {h}_{i , m} \neq 0 , {h}_{j , m} \neq 0 \\ \frac{{l}_{m}}{{h}_{j , m}} ρ ( {a}_{j , m} , {h}_{j , m} , {a}_{i , m} , {l}_{m} ) , & if {h}_{i , m} = 0 , {h}_{j , m} \neq 0 \\ \frac{{l}_{m}}{{h}_{i , m}} ρ ( {a}_{i , m} , {h}_{i , m} , {a}_{j , m} , {l}_{m} ) , & if {h}_{i , m} \neq 0 , {h}_{j , m} = 0 \\ ϕ ( \frac{{a}_{i , m} - {a}_{j , m}}{{l}_{m}} ) , & if {h}_{i , m} = 0 , {h}_{j , m} = 0\end{matrix} & ( 7 )\end{matrix}$$

where yᵢ is a i-th noisy observation from Eq. (2),

$${u}_{i} = \frac{1}{{V}_{i}} {\int }_{{V}_{i}}^{ } f ( x ) d x \\ and ρ ( a , h , x , l ) = Φ ( \frac{a + h / 2 - x}{l} ) - Φ ( \frac{a - h / 2 - x}{l} ) \qquad ( 8 )$$

As can be seen from Equations (5) and (8), Φ represents an integral and therefore, the covariance function is based on a difference between integrals of a basis function

$$R ( {a}_{1} , {a}_{2} , {h}_{1} , {h}_{2} , l ) = - Ψ ( \frac{{a}_{1} - {a}_{2} + ( {h}_{1} - {h}_{2} ) / 2}{l} ) + Ψ ( \frac{{a}_{1} - {a}_{2} - ( {h}_{1} + {h}_{2} ) / 2}{l} ) + Ψ ( \frac{{a}_{1} - {a}_{2} + ( {h}_{1} + {h}_{2} ) / 2}{l} ) - Ψ ( \frac{{a}_{1} - {a}_{2} - ( {h}_{1} - {h}_{2} ) / 2}{l} ) \qquad ( 9 )$$

Below is a list of exemplary covariance functions equivalent to Eq. (7) in the corresponding special cases. The following notations are used:

P: point; used for exploration assays.
L: vertical line; used for blasthole assays
V: volume; used for volume models like the block model 500

### Point, Point:

$$cov ( {X}_{P 1} , {X}_{P 2} ) = ϕ ( \frac{{a}_{P 1 , 1} - {a}_{P 2 , 1}}{{l}_{1}} ) ϕ ( \frac{{a}_{P 1 , 2} - {a}_{P 2 , 2}}{{l}_{2}} ) ϕ ( \frac{{a}_{P 1 , 3} - {a}_{P 2 , 3}}{{l}_{3}} )$$

### Point, Line:

$$cov ( {X}_{P} , {X}_{L} ) = ϕ ( \frac{{a}_{P , 1} - {a}_{L , 1}}{{l}_{1}} ) ϕ ( \frac{{a}_{P , 2} - {a}_{L , 2}}{{l}_{2}} ) \frac{{l}_{3}}{{h}_{L , 3}} ρ ( {a}_{L , 3} , {h}_{L , 3} , {a}_{P , 3} , {l}_{3} )$$

### Point, Volume:

$$cov ( {X}_{P} , {X}_{V} ) = \frac{{l}_{1}}{{h}_{V , 1}} ρ ( {a}_{V , 1} , {h}_{V , 1} , {a}_{P , 1} , {l}_{1} ) \frac{{l}_{2}}{{h}_{V , 2}} ρ ( {a}_{V , 2} , {h}_{V , 2} , {a}_{P , 2} , {l}_{2} ) \frac{{l}_{3}}{{h}_{V , 3}} ρ ( {a}_{V , 3} , {h}_{V , 3} , {a}_{P , 3} , {l}_{3} )$$

### Line, Line:

$$cov ( {X}_{L 1} , {X}_{L 2} ) = ϕ ( \frac{{a}_{L 1 , 1} - {a}_{L 2 , 1}}{{l}_{1}} ) ϕ ( \frac{{a}_{L 1 , 2} - {a}_{L 2 , 2}}{{l}_{2}} ) \frac{{l}_{3}^{2}}{{h}_{L 1 , 3} {h}_{L 2 , 3}} R ( {a}_{L 1 , 3} , {a}_{L 2 , 3} , {h}_{L 1 , 3} , {h}_{L 2 , 3} , {l}_{3} )$$

### Line, Volume:

$$cov ( {X}_{L} , {X}_{V} ) = \frac{{l}_{1}}{{h}_{V , 1}} ρ ( {a}_{V , 1} , {h}_{V , 1} , {a}_{L , 1} , {l}_{1} ) \frac{{l}_{2}}{{h}_{V , 2}} ρ ( {a}_{V , 2} , {h}_{V , 2} , {a}_{L , 2} , {l}_{2} ) \frac{{l}_{3}^{2}}{{h}_{L , 3} {h}_{V , 3}} R ( {a}_{L , 3} , {a}_{V , 3} , {h}_{L , 3} , {h}_{V , 3} , {l}_{3} )$$

### Volume, Volume:

$$\begin{matrix}cov ( {X}_{V 1} , {X}_{V 2} ) = \frac{{l}_{1}^{2}}{{h}_{V 1 , 1} {h}_{V 2 , 1}} R ( {a}_{V 1 , 1} , {a}_{V 2 , 1} , {h}_{V 1 , 1} , {h}_{V 2 , 1} , {l}_{1} ) \\ \frac{{l}_{2}^{2}}{{h}_{V 1 , 2} {h}_{V 2 , 2}} R ( {a}_{V 1 , 2} , {a}_{V 2 , 2} , {h}_{V 1 , 2} , {h}_{V 2 , 2} , {l}_{2} ) \\ \frac{{l}_{3}^{2}}{{h}_{V 1 , 3} {h}_{V 2 , 3}} R ( {a}_{V 1 , 3} , {a}_{V 2 , 3} , {h}_{V 1 , 3} , {h}_{V 2 , 3} , {l}_{3} )\end{matrix}$$

If only blast hole assays are received to update a volume model, then only cov(X_{L1},X_{L2}), cov(X_{L},X_{V}) and cov(X_{V1},X_{V2}) may be used. If exploration assays and blast hole assays are received to update a volume model then all the six covariance expressions may be used.

To speed up the learning process within the GP framework partial derivatives of the covariance function w.r.t. its hyper-parameters may be used. The partial derivatives will depend on the values of h_{i,q} and h_{j,q} and based on (7) can be calculated by the following four forms:

$$\begin{matrix} if \\ {h}_{i , q} \neq 0 , \\ {h}_{j , q} \neq 0 \\ then \\ \frac{\partial cov ( {u}_{i} , {u}_{j} )}{\partial {l}_{q}} = cov ( {u}_{i} , {u}_{j} ) [ \frac{2}{{l}_{q}} + \frac{1}{R ( \cdot )} ( \begin{matrix}\frac{{a}_{i , q} - {a}_{j , q} + ( {h}_{i , q} - {h}_{j , q} ) / 2}{{l}_{q}^{2}} Φ ( \frac{{a}_{i , q} - {a}_{j , q} + ( {h}_{i , q} - {h}_{j , q} ) / 2}{{l}_{q}} ) \\ - \frac{{a}_{i , q} - {a}_{j , q} - ( {h}_{i , q} + {h}_{j , q} ) / 2}{{l}_{q}^{2}} Φ ( \frac{{a}_{i , q} - {a}_{j , q} - ( {h}_{i , q} + {h}_{j , q} ) / 2}{{l}_{q}} ) \\ - \frac{{a}_{i , q} - {a}_{j , q} + ( {h}_{i , q} + {h}_{j , q} ) / 2}{{l}_{q}^{2}} Φ ( \frac{{a}_{i , q} - {a}_{j , q} + ( {h}_{i , q} + {h}_{j , q} ) / 2}{{l}_{q}} ) \\ \frac{{a}_{i , q} - {a}_{j , q} - ( {h}_{i , q} - {h}_{j , q} ) / 2}{{l}_{q}^{2}} Φ ( \frac{{a}_{i , q} - {a}_{j , q} - ( {h}_{i , q} - {h}_{j , q} ) / 2}{{l}_{q}} )\end{matrix} ) ] & ( 10 ) \\ if \\ {h}_{i , q} = 0 , \\ {h}_{j , q} \neq 0 \\ then \\ \frac{\partial cov ( {u}_{i} , {u}_{j} )}{\partial {l}_{q}} = cov ( {u}_{i} , {u}_{j} ) ( \frac{1}{{l}_{q}} + \frac{1}{ρ ( \cdot )} ( \begin{matrix}\frac{1}{{l}_{q}^{2}} ( {a}_{j , q} - {a}_{i , q} - {h}_{j , q} / 2 ) ϕ ( \frac{{a}_{j , q} - {a}_{i , q} - {h}_{j , q} / 2}{{l}_{q}} ) \\ - \frac{1}{{l}_{q}^{2}} ( {a}_{j , q} - {a}_{i , q} - {h}_{j , q} / 2 ) ϕ ( \frac{{a}_{j , q} - {a}_{i , q} + {h}_{j , q} / 2}{{l}_{q}} )\end{matrix} ) ) & ( 11 ) \\ if \\ {h}_{i , q} \neq 0 , \\ {h}_{j , q} = 0 \\ then \\ \frac{\partial cov ( {u}_{i} , {u}_{j} )}{\partial {l}_{q}} = cov ( {u}_{i} , {u}_{j} ) ( \frac{1}{{l}_{q}} + \frac{1}{ρ ( \cdot )} ( \begin{matrix}\frac{1}{{l}_{q}^{2}} ( {a}_{i , q} - {a}_{j , q} - {h}_{i , q} / 2 ) ϕ ( \frac{{a}_{i , q} - {a}_{j , q} - {h}_{i , q} / 2}{{l}_{q}} ) \\ - \frac{1}{{l}_{q}^{2}} ( {a}_{i , q} - {a}_{j , q} + {h}_{i , q} / 2 ) ϕ ( \frac{{a}_{i , q} - {a}_{j , q} + {h}_{i , q} / 2}{{l}_{q}} )\end{matrix} ) ) & ( 12 ) \\ if \\ {h}_{i , q} = 0 , \\ {h}_{j , q} = 0 \\ then \\ \frac{\partial cov ( {u}_{i} , {u}_{j} )}{\partial {l}_{q}} = - cov ( {u}_{i} , {u}_{j} ) \frac{{a}_{i , q} - {a}_{j , q}}{{l}_{q}^{2} ϕ ( \frac{{a}_{i , q} - {a}_{j , q}}{{l}_{q}} )} {ϕ}^{′} ( \frac{{a}_{i , q} - {a}_{j , q}}{{l}_{q}} ) & ( 13 )\end{matrix}$$

The quantities h_{i,q} and h_{j,q} in Eqs. (10)-(13) are the sizes of the volumes Vᵢ and Vⱼ corresponding to the axis x_{q}.

The function φ(·) used in Eq. (4) is the GP kernel defining the properties of the function ƒ(x). In the examples below, Squared Exponential, Exponential, Matern 3/2 and Matern 5/2 kernels are used for φ(·). The functions Φ(·) and ψ(·) defined in Eq. (5) for these covariance functions have the following forms:

### Squared Exponential

$$ϕ ( t ) = {e}^{- \frac{{t}^{2}}{2}} ; Φ ( t ) = \sqrt{\frac{π}{2}} erf ( \frac{t}{\sqrt{2}} ) ; \\ Ψ ( t ) = \sqrt{\frac{π}{2}} t erf ( \frac{t}{\sqrt{2}} ) + {e}^{- \frac{{t}^{2}}{2}} \qquad ( 14 )$$

### Exponential

φ(t)=e^{-|t|}; Φ(t)=sgn(t)(1−e^{-|t|}); ψ(t)=|t|+e−|t| (15)

### Matern 3/2

$$ϕ ( t ) = ( 1 + \sqrt{3} \vert t \vert ) {e}^{- \sqrt{3} \vert t \vert} ; \\ Φ ( t ) = \frac{2}{\sqrt{3}} sgn ( t ) ( 1 - ( 1 + \frac{\sqrt{3}}{2} \vert t \vert ) {e}^{- \sqrt{3} \vert t \vert} ) \\ Ψ ( t ) = \frac{2}{\sqrt{3}} \vert t \vert + ( 1 + \frac{1}{\sqrt{3}} \vert t \vert ) {e}^{- \sqrt{3} \vert t \vert} \qquad ( 16 )$$

### Matern 5/2

$$ϕ ( t ) = ( 1 + \sqrt{5} \vert t \vert + \frac{5}{3} {t}^{2} ) {e}^{- \sqrt{5} \vert t \vert} ; \\ Φ ( t ) = \frac{sgn ( t )}{3} ( \frac{8}{\sqrt{5}} - ( \frac{8}{\sqrt{5}} + 5 \vert t \vert + \sqrt{5} {t}^{2} ) {e}^{- \sqrt{5} \vert t \vert} ) ; \\ Ψ ( t ) = \frac{1}{3} ( \frac{8}{\sqrt{5}} \vert t \vert + ( 3 + \frac{7}{\sqrt{5}} \vert t \vert + {t}^{2} ) {e}^{- \sqrt{5} \vert t \vert} ) \qquad ( 17 )$$

The case of distant volumes comes across when the values of arguments in functions φ(·), Φ(·) and ψ(·) become very large. This case may considered separately because in this case the values of ρ(·) and R(·) functions and their derivatives become zero. Therefore, in this case the expressions will contain indefinite expressions of the form 0/0 in Eqs. (10)-(13). This is why algebraic manipulations are conducted to resolve the 0/0 indefinite expressions for this case.

In one example, the presented forms of the functions ρ(·) and R(·) are assumed to be valid when Eq. (5) takes place within the interval

$$t ∈ [ \frac{{a}_{i , m} - {a}_{j , m} - ( {h}_{i , m} + {h}_{j , m} ) / 2}{{l}_{m}} , \frac{{a}_{i , m} - {a}_{j , m} + ( {h}_{i , m} + {h}_{j , m} ) / 2}{{l}_{m}} ] \qquad ( 18 )$$

The case of distant volumes comes across when

$$\vert {a}_{i , m} - {a}_{j , m} \vert \geq \frac{( {h}_{i , m} + {h}_{j , m} )}{2} . \qquad ( 19 )$$

This means that the selection of the covariance function is based on the distance between the modelling point and the anchor point.

It can be shown that if Eq. (19) takes place then the first member |t| in the function ψ(t) can be omitted in Eqs. (15)-(17) for the interval (18). Let's demonstrate it for the case of Matern 3/2 kernel:

$$\begin{matrix}Φ ( t ) = \frac{2}{\sqrt{3}} sgn ( t ) ( 1 - ( 1 + \frac{\sqrt{3}}{2} \vert t \vert ) {e}^{- \sqrt{3} \vert t \vert} ) + C \\ = - \frac{2}{\sqrt{3}} sgn ( t ) ( 1 + \frac{\sqrt{3}}{2} \vert t \vert ) {e}^{- \sqrt{3} \vert t \vert} + C + \frac{2}{\sqrt{3}} sgn ( t ) \\ = - \frac{2}{\sqrt{3}} sgn ( t ) ( 1 + \frac{\sqrt{3}}{2} \vert t \vert ) {e}^{- \sqrt{3} \vert t \vert} + {C}_{0}\end{matrix}$$

Because of Eq. (19) here

$$\frac{2}{\sqrt{3}} sgn ( t ) = \frac{2}{\sqrt{3}} sgn ( \frac{{a}_{i , m} - {a}_{j , m} ∓ ( {h}_{i , m} - {h}_{j , m} ) / 2}{{l}_{m}} ) = \frac{2}{\sqrt{3}} sgn ( {a}_{i , m} - {a}_{j , m} ) ,$$

therefore taking

$$C = - \frac{2}{\sqrt{3}} sgn ( {a}_{i , m} - {a}_{j , m} )$$

results in C₀=0. This shows that the member

$$\frac{2}{\sqrt{3}} \vert t \vert$$

in the function ψ(t) can be omitted for the calculations.

As multiplication of φ(t), Φ(t) and ψ(t) functions by the constant

$${e}^{\frac{\vert {a}_{1} - {a}_{2} \vert}{l}}$$

will not change the value of

$$\frac{\partial cov ( {u}_{i} , {u}_{j} )}{\partial {l}_{q}} ,$$

in the case of distant volumes the functions may be used:

$$ϕ ( t ) = ( 1 + \sqrt{3} \vert t \vert ) {e}^{- \sqrt{3} ( \vert t \vert - \frac{\vert {a}_{1} - {a}_{2} \vert}{l} )} \\ Φ ( t ) = - \frac{2}{\sqrt{3}} sgn ( t ) ( 1 + \frac{\sqrt{3}}{2} \vert t \vert ) {e}^{- \sqrt{3} ( \vert t \vert - \frac{\vert {a}_{1} - {a}_{2} \vert}{l} )} \\ Ψ ( t ) = ( 1 + \frac{1}{\sqrt{3}} \vert t \vert ) {e}^{- \sqrt{3} ( \vert t \vert - \frac{\vert {a}_{1} - {a}_{2} \vert}{l} )} \qquad ( 20 )$$

instead of Eq. (16). Similar situation apply for the case of Exponential (15) and Matern 5/2 (17) kernels.

Based on the derivations of the previous sections the strategy for updating the EPR model using the blasthole assays can be defined as follows:
1. Choose the model dataset from the bench of interest (in one example bench 242). Take blasthole assays from the bench 240 above.
2. Combine both datasets into a single dataset using the suggested unified mathematical representation Eq. (1).
3. Learn hyper-parameters by applying the GP to the blasthole assays from the bench 240 above. Use the derivatives (10)-(13) of the covariance function (7) for speeding up the optimisation process.
4. Infer average iron content in the EPR blocks of the bench 242 for finding the corresponding uncertainties, i.e. the standard deviations std_{BH}.
5. Define the noise for the EPR dataset in the following way
   5.1. Calculate the number of blasthole assays Cᵢ belonging to each i-th EPR block.
   5.2. Calculate the density of blasthole assays

$$D = \frac{1}{M} {\sum }_{i = 1}^{M} {C}_{i} .$$

Here M is a number of EPR blocks with Cᵢ≠0.
5.3. Use the following expression for the EPR noise

$${noise}_{EPR} = \{ \begin{matrix}D \cdot ( max ( {std}_{BH} ) - {std}_{BH} ) & if {C}_{i} \neq 0 ; \\ 0.01 & if {C}_{i} = 0 ;\end{matrix} .$$

This allows to update the EPR model when there are blasthole assays in its block and leave EPR unchanged otherwise.
6. Apply the GPs to the combined EPR-blasthole dataset using the learned hyper-parameters and defined EPR noise.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating” or “generating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer-implemented method for updating an estimate for a material property of a volume, the estimate being based on values of one or more model parameters, the method comprising:
(a) receiving a measurement of the material property outside the volume;
(b) determining updated values for the one or more model parameters based on the estimate and the measurement; and
(c) determining an updated estimate for the material property of the volume based on the updated values for the one or more model parameters and the measurement.

2. The method of claim 1, wherein the measurement is point data, a surface average or a line average.

3. The method of claim 1 or 2, wherein the measurement is associated with a first bench of a mine pit.

4. The method of claim 3, wherein the volume is associated with a second bench of a mine pit and the second bench is below the first bench.

5. The method of claim 4, wherein the second bench is immediately below the first bench.

6. The method of any one of the preceding claims, wherein the measurement is a drill hole assay.

7. The method of any one of the preceding claims, wherein the measurement is obtained while drilling.

8. The method of any one of claim 7, wherein the measurement is based on a drill penetration rate.

9. The method of any one of the preceding claims, wherein the measurement is based on a hyperspectral surface scan.

10. The method of any one of the preceding claims, wherein the material property is a material concentration.

11. The method of any one of the preceding claims further comprising generating a display of the volume, such that the visual appearance of the volume is based on the updated estimate for the material property.

12. The method of claim 11, wherein the display comprises a visual representation of at least part of a mine pit including multiple volumes.

13. The method of any one of the preceding claims, wherein the volume has a first number of dimensions and the measurement has a second number of dimensions being less than the first number of dimensions.

14. Software, that when installed on a computer causes the computer to perform the method of any one or more of claims 1 to 13.

15. A computer system for updating an estimate for a material property of a volume, the estimate being based on values of one or more model parameters, the computer system comprising:
a data port to receive a measurement of the material property outside the volume;
a processor to determine updated values for the one or more model parameters based on the estimate and the measurement and to determine an updated estimate for the material property of the volume based on the updated values for the one or more model parameters and the measurement; and
a data store to store the updated estimate.

16. A computer implemented method for modelling data, the method comprising:
(a) receiving a first set of data values, each value being based on an estimated physical property having a first number of dimensions;
(b) receiving a second set of data values, each value being based on an estimated physical property having a second number of dimensions; and
(c) selecting based on the first and second number of dimensions one of multiple functions to model the first and second set of data values.

17. The method of claim 16, further comprising determining estimated data values based on the first set of data values, the second set of data values and the selected one of multiple functions.

18. The method of claim 17, further comprising generating a display comprising a graphical representation of the estimated data values.

19. The method of claim 18, wherein each data value is associated with one location of the display and the colour of that point in the visual representation is based on that data value.

20. The method of any one of claims 16 to 19, further comprising:
receiving a request for an estimated data value at a request location;
determining the estimated data value based on the request location, the first set of data values, the second set of data values and the selected one of multiple functions; and
sending the estimated data value.

21. The method of any one of claims 16 to 20, wherein the first set of data values is based on an average of the estimated first physical property over the first number of dimensions and the second set of data values is based on an average of the estimated second physical property over the second number of dimensions.

22. The method of claim 21, wherein the first number of dimensions is three.

23. The method of claim 21 or 22, further comprising determining the average of the estimated first physical property using a geological model.

24. The method of any one of claims 16 to 23, wherein the first and second physical properties are material concentrations.

25. The method of any one of claims 16 to 24, wherein the second number of dimensions is one.

26. The method of claim 25, wherein each of the second set of data values is based on an average of the estimated second physical property over at least part of a drill hole.

27. The method of any one of claims 16 to 26, wherein the multiple functions are covariance functions.

28. The method of any one of claims 16 to 27, wherein where the second number of dimensions is smaller than the first number of dimensions the selected function is based on a difference between integrals of a basis function.

29. The method of any one of claims 16 to 28, further comprising determining parameters of the multiple functions based on the first and second set of data values.

30. The method of any one of claims 16 to 29, wherein the multiple functions are based on one or more of:
squared exponential,
exponential,
Matern 3/2, and
Matern 5/2.

31. The method of any one of claims 16 to 30, wherein selecting the function is based on a distance between a modelling point and the anchor point.

32. Software, that when installed on a computer causes the computer to perform the method of any one or more of the claims 16 to 31.

33. A computer system for modelling data, the computer system comprising:
a data port to receive a first set of data values, each value being based on an estimated physical property having a first number of dimensions, and to receive a second set of data values, each value being based on an estimated physical property having a second number of dimensions; and
a processor to select based on the first and second number of dimensions one of multiple functions to model the first and second set of data values.

34. A data format for storing on a non-transitory medium model data, the data format comprising:
a first set of data values, each value being based on an estimated first physical property having a first number of spatial dimensions;
a second set of data values, each value being based on an estimated second physical property having a second number of spatial dimensions, the second number of spatial dimensions being smaller than the first number of spatial dimensions, wherein each value of the first set and each value of the second set is associated with an anchor point and a size vector, the anchor point and the size vector having the first number of spatial dimensions.

35. A computer implemented method for storing on a non-transitory medium data to be fused with a first set of data values, each value being based on an estimated physical property having a first number of spatial dimensions, the method comprising:
receiving a second set of data values, each value being based on an estimated physical property having a second number of spatial dimensions, the second number of spatial dimensions being smaller than the first number of spatial dimensions; and
storing for each value of the second set an association with an anchor point and a size vector, the anchor point and the size vector having the first number of spatial dimensions.

36. Software, that when installed on a computer causes the computer to perform the method of claim 35.

37. A computer system for storing on a non-transitory medium data to be fused with a first set of data values, each value of the first set of data values being based on an estimated physical property having a first number of spatial dimensions, the computer system comprising:
a data port to receive a second set of data values, each value being based on an estimated physical property having a second number of spatial dimensions, the second number of spatial dimensions being smaller than the first number of spatial dimensions; and
a processor to store for each value of the second set an association with an anchor point and a size vector, the anchor point and the size vector having the first number of spatial dimensions.
